(19) United States
(12) Patent Application Publication
(10) Pub. No.: US 2007/0291923 A1
(43) Pub. Date: Dec. 20, 2007

(54) Method and apparatus for the purchase, sale and facilitation of voice over internet protocol (VoIP) consultations

(76) Inventor: Amy Hsieh, Sunnyvale, CA (US)

Correspondence Address: Jerry Tao, 9168 Dalmahoy Place, Las Vegas, NV, 89145, US

(21) Appl. No.: 11/455,250

(22) Filed: Jun. 19, 2006

(51) Int. Cl. H04M 3/00; H04M 5/00

(52) U.S. Cl. 379/265.01

(57) ABSTRACT

The present invention relates to a novel method and apparatus for facilitating voice-to-voice communication in an on-line environment between requestors seeking advice and helpers providing advice. The invention comprises a user-friendly website interface in which a plurality of helpers and requesters can provide personal data relating to their qualifications or information about the subject matter they wish to discuss through the posting of text or pictorial information. The information can be organized and categorized in a variety of ways such as, for example, to be accessible through a search engine. Visitors can review the information provided; identify a helper or requestor with whom they wish to establish communication; purchase or sell these services; and initiate VoIP voice-to-voice communication directly with an individual through the website.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention relates generally to a method and apparatus for facilitating person-to-person communication in an on-line environment between requesters seeking advice and helpers providing advice, and facilitating the purchase or sale of those services.

Over the past decade, the technology known colloquially as “e-commerce” has flourished. A typical on-line purchase involves customers purchasing goods and services on a retailer's website using a credit card, which is then processed by the retailer or a third-party payment processing company. After payment is received, the product or good is shipped or mailed to an address specified by the customer. Millions of these on-line purchases have been made over the past several years.

Internet technology has also allowed customers to purchase products not only from large commercial retailers, but also from other individuals who wish to sell items in their personal possession. There are several ways to accomplish this. For example, individuals may sell their personal possessions directly through their own websites. Alternatively, individuals may seek purchasers by advertising their items on any of a number of on-line “classified ad” services that are widely available and popular.

One of the most popular methods for facilitating such person-to-person transactions over the Internet is through an on-line auction service, the most widely known example of which is eBay. eBay allows sellers to upload text descriptions and photographs of their items onto a website created and hosted by eBay. Potential purchasers can use a search engine to locate items of particular interest to them, view the available products, and submit “bids” to purchase the products that they desire. Because these transactions occur between an individual seller dealing directly with an individual purchaser, they are sometimes referred to as a “person-to-person” transactions. See, for example, U.S. Pat. No. 7,007,076 to Hess et al.

The advantages of using on-line auctions such as eBay for such person-to-person transactions are readily apparent. From the point of view of the seller, more potential customers are likely to visit a widely-used site such as eBay than are likely to visit a single website created by an individual person. Furthermore, if more than one potential purchaser submits bids, the presence of competing bids helps the seller obtain a higher selling price. Conversely, from the point of view of the purchaser, sites such as eBay conveniently provide a wide variety of available products in one location which makes it far easier to search for and find a particular product for purchase.

The vast majority of existing e-commerce transactions involve the sale of consumer products or other items in which voice communications do not play an important part. Moreover, most existing websites cannot accommodate direct voice-to-voice transactions.

Recently, development of technology known as Voice over Internet Protocol (also called VoIP, IP Telephony or Internet telephony) has allowed voice-to-voice communication directly over the Internet. Voice over Internet Protocol is the routing of voice conversations over the Internet or through any IP-based network.

The development of VoIP technology makes possible the marketing or sale of voice-to-voice consulting or other services directly over the Internet. However, a need exists for an online community using innovative methods and apparatus for facilitating voice-to-voice communications between parties.

One advantage of the worldwide availability of the Internet is the ability to readily retrieve information on a wide range of topics through the use of search engines such as Yahoo! or Google. However, these conventional and popular approaches are quite limited. They are essentially passive experiences, in the sense that users can view the information that is available, but cannot engage in ongoing dialogue with experts. Additionally, if users want to obtain information on a topic or subject area that is very narrow, specialized, arcane, highly technical, or otherwise known only to a relatively small segment of the population, there is a strong possibility that no website containing that particular information exists since the commercial incentives for creating such a specialized website would be very limited.

One solution to this limitation is provided, by way of example, through a service called “Ask Yahoo!,” which allows a user to type a question on the Yahoo! website. The question is publicly posted for other visitors to respond to the question. All of the responses are displayed so that the questioner (or other visitors who are interested in the same question) can view the responses. However, this type of service is also limited in that the original questioner cannot ask follow-up questions or engage in a dialogue with those who respond in order to obtain additional information. Moreover, the service only allows both questions and answers to be posted in written form; this is partly due to the fact that the purpose of the service is to preserve the questions and answers so that they may be viewed at a later time by other visitors to the website. In this context, voice-to-voice communication is not possible, or even desirable.

Another form of accessing information that is somewhat mote interactive is through message boards devoted to particular topics. On those message boards, users may exchange messages with others about subjects, and may post follow-up questions to obtain further information. However, these message boards are in written form so that the messages may be preserved and viewed at a later time by other users who access the boards.

In certain instances, a person seeking advice, answers or consultation on a particular matter, or a person offering answers or advice or consultation on a particular matter, may prefer or require direct voice-to-voice communication that is not possible with existing text-based on-line methods of providing such advice.

Accordingly, a need exists for a method and apparatus for facilitating voice-to-voice communications between parties using VoIP or similar technology which overcomes these disadvantages and limitations.

### BRIEF SUMMARY OF THE INVENTION

The present invention relates to a novel method and apparatus for facilitating person-to-person communication in an on-line environment between requestors seeking advice and helpers providing advice, and facilitating the purchase or sale of those services.

The invention comprises a user-friendly website interface in which a plurality of helpers and requestors can provide personal data relating to their qualifications or information about the subject matter they wish to discuss through the posting of text or pictorial information. The information can be organized and categorized in a variety of ways, such as, for example, to be accessible through a search engine. Visitors can review the information provided; identify a helper or requestor with whom they wish to establish communication; purchase or sell these services; and initiate VoIP voice-to-voice communication directly with an individual through the website.

### BRIEF DESCRIPTION OF THE SEVERAL VIEWS OF THE DRAWING

Not Applicable.

### DETAILED DESCRIPTION OF THE INVENTION

The present invention relates to a novel method and apparatus for facilitating person-to-person communication in an on-line environment between requesters seeking advice and helpers providing advice, and facilitating the purchase or sale of these services.

The following description is intended to be illustrative and is not intended to limit or restrict the scope of the invention as defined by the appended claims. In the following description, for the purposes of explanation, numerous specific details are set forth in order to provide a thorough understanding of the present invention. It will be apparent, however, to one skilled in the art that the present invention may be practiced without some of these specific details, and that equivalents or alternatives that are readily apparent to those in the art may be substituted without affecting the scope of the present invention.

As will be described in greater detail below, the present invention includes a website (or a series of linked websites or webpages) capable of displaying information provided by both people (“requestors”) who desire advice, information or consultation (hereinafter collectively referred to as “advice”) concerning a particular topic as well as people interested in providing advice on particular matters (“helpers”). The information displayed can be text or pictorial, in the form of photos, logos, or video clips, and can display any information that might attract inquiries from helpers or requestors, including, for example, the qualifications of the person supplying the information, a description of the information sought or provided, the interests or experiences of the helper or requestor, or the like.

The present invention would be ideally suited for commercial fee-for-service consultations involving voice-to-voice communication, such as, for example, psychic readings, psychiatric sessions between a patient and a doctor, physician-to-physician consultation on particular cases, relationship advice, or the like. However, the precise application or context is not an essential or material part of the present invention; rather, the present invention could also be utilized in a variety of other contexts, including non-commercial contexts, without affecting the scope or utility of the invention.

Once a helper or requestor has provided information and been assigned a link as described below, the present invention could allow any visitor to the site who has VoIP capability to communicate with that helper or requestor even if that visitor has not supplied his own helper or requestor information. In other words, although the following description will refer to “helpers” who provide advice, the term “helper” refers broadly to visitors to the website who wish to communicate with requestors who have provided information, whether or not the helper himself has provided information or been identified as such on the website. Similarly, although the following description will refer to “requesters” who seek advice, the term “requestor” refers broadly to visitors to the website who wish to communicate with helpers who have provided information, whether or not the requestor himself has provided information or been identified as such on the website.

Furthermore, although the operation of the present invention will be discussed assuming that a helper would prefer to communicate with a requestor, and vice-versa, it should be readily apparent that in certain circumstances helpers might also be interested in communicating with other helpers, and requestors might also be interested in communicating with other requestors, and that the present invention would permit such helper-helper and requestor-requestor communications to occur in a manner that should be readily apparent to those skilled in the art and fully consistent with the spirit and letter of the present invention.

In the simplest embodiment, the website is arranged in such a way that helpers and requestors can provide whatever text or pictorial information they desire regarding their qualifications or the particular advice in which they are interested. For example, a psychologist wishing to offer his services on-line could provide his name, educational background, work experience, and the fees that he charges for his services, or any other information that might attract inquiries from potential clients. Similarly, a requestor seeking such services could provide a summary of the problems for which he seeks help, and the price that he is willing to pay, or any other information that might attract interest from potential helpers or requestors. Each helper or requestor who participates would be assigned a link on the website by the administrator of the website. The link would, if clicked on, initiate a VoIP voice-to-voice communication between the person who clicked on the link and the person to whom the link is assigned. Preferably, the link should be displayed adjacent to, or even incorporated as a part of, the information supplied by that person that is displayed on the website.

The information provided by all helpers and requesters who have submitted information can then be organized and arranged on the website in a manner that is readily accessible by visitors to the site. The information could be organized by the helpers/requestors themselves, or by the website administrator or operator, using any criteria or method that proves most useful or advantageous in view of the quality or type of information submitted. For example, the information could be arranged by subject matter, field of expertise, price range, or any other category that proves useful. By way of example, one category could list helpers providing advice relating to psychic services; another category could list requesters seeking those services; other categories could list helpers and requestors seeking psychiatric services, business consulting, tax advice, medical advice, or the like. Many other combinations or alternatives will be readily apparent and can be modified based upon the preferences of the particular helpers or requesters who use the website.

Once displayed, the information can then be viewed by other helpers or requestors who visit the website seeking to solicit or provide advice. The website could include a search engine feature through which helpers or requesters could conduct textual searches or queries for specific types or categories of information, subject areas, topics, price ranges, or the names or other information relating to specific helpers or requestors, that interest them. Many types of search engines are known that can be utilized with the present invention.

In an alternative embodiment, each helper seeking advice, or each requestor offering advice, could also specify the dates and times on which he is available for voice-to-voice communication. This could be accomplished in its simplest form by simply including the available dates and times within the information provided by the particular helper or requestor. Additionally, the website could also include a calendar program which prevents VoIP communication with the particular helper or requestor unless the current date and time match the available times specified by the particular helper or requestor. Alternatively, a means could be provided by which users could arrange appointments in advance on specific dates or times on a virtual calendar displayed along with the information. When a requester selects a particular date or time for an appointment, the calendar program could notify the helper of the appointment via e-mail or other means so that he can ensure that he is available and ready to participate in the VoIP communication at that time.

In another embodiment, because it is contemplated that at least some of the voice-to-voice transactions facilitated through this invention will be commercial, the invention also contemplates that each helper providing advice could accept credit card payments from requestors prior to or contemporaneously with the VoIP communication being established. This could be accomplished through several ways. For example, the website could provide a link to a commercial credit card processing service so that requesters using the website could supply credit card information, and be billed for payment. Alternatively, the website could allow a requestor to transmit his credit card information directly to the helper for processing.

The invention also contemplates that the information provided by each helper or requestor for display on the website would be linked to a VoIP address associated with each helper or requestor. In this way, direct VoIP communication could conveniently be established through the website interface without the parties having to leave the website or go to another website.

Referring to yet another alternative embodiment, the website could also employ a feature allowing helpers or requesters to post or display their comments or “reviews” or “ratings” on the website relating to various helpers or requestors with whom they have communicated. Thus, for example, after a requestor has communicated with a particular helper, the requestor could then allow the requester to provide information for display relating to the quality of the conversation or the services he obtained. These reviews or ratings could be textual, i.e., the requestor could type in his comments and observations in text form, or they could be numerical, i.e., the requestor could rate the quality of the helper on a numerical scale (e.g., a scale of 1 to 4, or 1 to 10, or any other similar scale), or some combination of both. This review or rating could be viewed on the website by other requesters who are considering communicating with that helper, to assist them in deciding whether they wish to initiate communication with that particular helper, or to use another helper instead. The technology associated with allowing users to post their own reviews or ratings of a particular commodity or service are known in the art and common to other commercial websites, such as, for example, websites reviewing the quality of hotels and motels. Once displayed, this information could not be modified by the helper to whom the rating or review pertains, in order to prevent helpers from deleting poor reviews posted by others in order to make their services seem more valuable or attractive.

Utilizing the above-described arrangement, the invention would operate as follows. Helpers and requestors hoping to advertise themselves on the website could access the website at their leisure and enter their text or pictorial information for display on the website. This information would be arranged and categorized, either by the helper or requestor himself, or by the website administrator, so as to be readily accessed in an understandable and intelligent manner by visitors wishing to solicit the services of a helper or requester. The invention could also employ a search engine by which visitors to the site could search for specific information via text queries, such as, for example, queries for specific types of advice, or specific helpers or requestors, or the like.

Once information from different helpers and requestors is supplied, organized and displayed on the website, requesters who seek advice could peruse the various entries and decide, based on the information displayed, including any reviews or rating posted by others, whether he wishes to establish communication with a particular helper. Alternatively, helpers wishing to locate requestors interested in his advice could peruse the various entries and decide, based on the information displayed, including any reviews or ratings posted by others, whether he wishes to establish communication with a particular requester.

Once either a helper or requestor identifies someone with whom he wishes to establish communication, he would then click on the link corresponding to that person's information. VoIP voice-voice communication could then be immediately established. Once established, the helper and requestor can then begin a voice-to-voice conversation concerning the advice being sought, or any other matter that the two parties might be interested in discussing.

Alternatively, if the person being contacted has specified certain dates and times on which he is available for communication, and has utilized a calendar program as described above, the clicking of the link could initiate the operation of the calendar program to determine if the person is currently available. If he is not currently available, then communication would not be established, and a message indicating that the person is not available could be displayed. If he is available, then communication could be established.

Alternatively, if the person being contacted is engaged in offering advice for a fee, then the clicking of the link could divert to a credit card processing company, which would then require the entry of a credit card number for processing. Once a credit card number is successfully entered, communication could then be established.

After VoIP communication is established and completed, the helper or requestor could then create a review or rating pertaining to the person with whom he spoke, which would be displayed on the website to be viewed by other helpers or requestors considering the service of that particular person.

The present invention expressly contemplates simultaneous use by numerous helpers and requestors, similar to the manner in which on-line auction sites permit numerous users to simultaneously search for, review and submits bids for products. However, the purpose of this site is the sale and facilitation of voice-to-voice consultations, rather than for the person-to-person sale of physical products. At any given time, numerous users could be uploading information for display on the website, searching for helpers or requestors and reviewing their information, or communicating with requesters or helpers. The number of users would be limited only by existing technology and the amount of bandwidth available to support simultaneous website use and VoIP communication as is known by those skilled in the art.

Thus, the present invention permits a variety of helpers interested in providing advice on subject areas of their choice to identify themselves and provide information relating to their services or their areas of expertise on a single website. The information can be viewed by any number of requestors seeking advice, who can then select one or more helpers with whom to communicate. Communication can then be easily established directly through the website.

Conversely, the present invention also permits a variety of requestors who seek advice concerning various subject areas to display information relating to their requests on a single website. The information can be viewed by any number of helpers seeking to locate clients who might be interested in their advice. Communication can then be easily established directly through the website.

Thus, the present invention provides a novel and advantageous method and apparatus for facilitating person-to-person communication in an on-line environment between multiple requestors seeking advice on a plurality of subject areas, and a variety of helpers providing advice, and for facilitating the purchase or sale of these consultation services.

In the foregoing specification, the invention has been described with reference to specific embodiments thereof. It will, however, be evident that various modifications and changes may be made thereto without departing from the broader spirit and scope of the invention as defined in the appended claims. The specification and drawings are, accordingly, to be regarded in an illustrative rather than a restrictive sense.

1. A method for facilitating person-to-person communication in an on-line environment between requesters seeking advice, and helpers providing advice, the method comprising the steps of:
displaying, on at least one web site, text and/or pictorial images corresponding to information provided by the requestors; and
in response to an action by a helper, establishing a communication link between a requestor and the helper so that the helper and requestor can speak directly with each other.

2. The method of claim 1 wherein the communication link is VoIP.

3. The method of claim 2 wherein the VoIP communication link can be accessed directly from the web site.

4. The method of claim 1 wherein the information provided is organized in a manner searchable via a search engine.

5. The method of claim 1 further comprising the step of enabling monetary payment to be transferred from the requestor to the helper in return for the advice either in advance of, or concurrently with, establishing the communication link.

6. The method of claim 5 wherein the monetary payment is a credit card payment.

7. The method of claim 1 further comprising the step of determining, prior to establishing the communication link, whether the requestor and helper are presently available for communication, and if not, then denying the establishment of the communication link.

8. The method of claim 1, further comprising the step of, after the helper and requestor have finished speaking, enabling the helper to enter information for display on the website pertaining to the quality or performance of the requester.

9. A method for facilitating person-to-person communication in an on-line environment between helpers capable of providing advice, and requesters seeking advice, the method comprising the steps of:
displaying, on at least one web site, text and/or pictorial images corresponding to information provided by the helpers; and
in response to an action by a requestor, establishing a communication link between the requestor and a helper so that the helper and requestor can speak directly with each other.

10. The method of claim 9 wherein the communication link is VoIP

11. The method of claim 10 wherein the VoIP communication link can be accessed directly from the web site.

12. The method of claim 9 wherein the information provided is organized in a manner searchable via a search engine.

13. The method of claim 9 further comprising the step of enabling monetary payment to be transferred from the requestor to the helper in return for the advice either in advance of, or concurrently with, establishing the communication link.

14. The method of claim 13 wherein the monetary payment is a credit card payment.

15. The method of claim 9 further comprising the step of determining, prior to establishing the communication link, whether the requestor and helper are presently available for communication, and if not, then denying the establishment of the communication link.

16. The method of claim 9, further comprising the step of, after the helper and requestor have finished speaking, enabling the requester to enter information for display on the website pertaining to the quality or performance of the helper.

17. An apparatus for facilitating person-to-person communication in an on-line environment between requestors seeking advice, and helpers providing advice, comprising:
at least one website capable of displaying text and/or pictorial images corresponding to information provided by the helpers and requestors; and
a plurality of communication links operatively linked to website and capable of enabling at least one helper to communicate with at least one requestor on a voice-to-voice basis.

18. The apparatus of claim 17 wherein the communication link is a VoIP communication link which can be accessed directly from the website.

19. The apparatus of claim 17 further comprising a credit card processing apparatus for enabling monetary payment to be transferred from the requestor to the helper in return for the advice either in advance of, or concurrently with, establishing the communication between the helper and requestor.

20. The apparatus of claim 17 further comprising a calendar program for determining, prior to establishing the communication link, whether the requestor and helper are presently available for communication, and if not, then denying the establishment of the communication between the helper and requestor.
